(19) United States
(12) Patent Application Publication
(10) Pub. No.: US 2009/0114809 A1
(43) Pub. Date: May 7, 2009

(54) ISOTOPE RATIO MASS SPECTROMETER AND METHODS FOR DETERMINING ISOTOPE RATIOS

(75) Inventors: Michael Hotchkis, New South Wales (AU); Christopher Leslie Waring, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: Australian Nuclear Science & Technology Organisation, Lucas Height, NSW (AU)

(21) Appl. No.: 12/065,497

(22) PCT Filed: Sep. 1, 2006
(86) PCT No.: PCT/AU06/01284

§ 371 Date: Jul. 16, 2008

(30) Foreign Application Priority Data
Sep. 2, 2005 (AU) 2005904829

(51) Int. Cl. B01D 59/44; H01J 49/00

(52) U.S. Cl. 250/282; 250/281

(57) ABSTRACT

The present invention relates to a method for determining at least one ratio of different isotopes of at least one element in a sample. The method comprises ionizing the sample to produce ions of the different isotopes of the at least one element, the ions being selected from the group consisting of: multiply charged atomic positive ions, single charged positive ions for hydrogen and single charged positive ions for deuterium, separating the charged positive ions of the different isotopes of the at least one element according to their mass-to-charge ratios, and determining at least one ratio of the different isotopes of said at least one element separated in the previous step. The invention also relates to an apparatus for performing the above method.

### TECHNICAL FIELD

The present invention relates to an isotope ratio mass spectrometer and the use of same in the determination of isotopic ratios.

### BACKGROUND OF THE INVENTION

Existing isotope ratio mass spectrometers can measure carbon, nitrogen, oxygen and sulfur isotope ratios in a variety of samples and are available with sample processing units tailored to different sample types. However, such spectrometers suffer from a number of disadvantages. Firstly, existing spectrometers use molecular ion species for isotope analysis which leads to the overlapping of atomic peaks and molecular peaks. This interference requires the spectra to be deconvoluted, which is a difficult and time consuming task, and sometimes is unable to resolve isobaric interference from different molecular ions.

In addition, most existing spectrometers are unable to measure ¹⁷O, and where they can the sample must be converted to highly pure oxygen gas to enable the measurement to be performed. For example, using current methods it is impractical to measure ¹⁷O directly in CO₂ samples because existing spectrometers measure molecular ions and therefore at mass 45 they cannot resolve ¹³C¹⁶O¹⁶O from ¹²C¹⁶O¹⁷O. A further problem also arises in that the ¹³C measurement must be corrected for an assumed small contribution from ¹⁷O at mass 45. Furthermore, where it is desired to measure ¹⁸O in water samples, existing spectrometers require at least 0.1 ml of water and the sample processing unit required for ¹⁸O is very expensive. Yet another problem with present spectrometers is their inability to measure water directly. Water samples must first be converted to CO₂ by a complex method requiring large samples.

Accordingly, against this background there is a need for an isotope ratio mass spectrometer which addresses at least some of the above disadvantages of known spectrometers.

### SUMMARY OF THE INVENTION

A1. In a first aspect, the present invention provides a method for determining at least one ratio of different isotopes of at least one element in a sample said method comprising:

(i) ionizing the sample to produce ions of the different isotopes of said at least one element, said ions being selected from the group consisting of: multiply charged atomic positive ions, single charged positive ions for hydrogen and single charged positive ions for deuterium;

(ii) separating the charged positive ions of the different isotopes of said at least one element according to their mass-to-charge ratios; and

(iii) determining at least one ratio of the different isotopes of said at least one element separated in step (ii).

A2. The method of A1 may comprise determining at least one ratio of different isotopes of a single element in a sample, said method comprising:

(i) ionizing the sample to produce ions of the different isotopes of the element, said ions being selected from the group consisting of: multiply charged atomic positive ions, single charged positive ions for hydrogen and single charged positive ions for deuterium wherein the mass-to-charge ratios of the charged positive ions of the different isotopes are in a mass-to-charge ratio range that is different to the mass-to-charge ratio of other ions produced from said sample;

(ii) separating the charged positive ions of the different isotopes of the element according to their mass-to-charge ratios; and

(iii) determining at least one ratio of the different isotopes of the element separated in step (ii).

A3. The method of A1, may comprise determining at least one ratio of different isotopes of at least two different elements in a sample said method comprising:

(i) ionizing the sample to produce ions of the different isotopes of said at least two different elements, said ions being selected from the group consisting of: multiply charged atomic positive ions, single charged positive ions for hydrogen and single charged positive ions for deuterium, wherein the mass-to-charge ratios of the charged positive ions of the different isotopes are in a mass-to-charge ratio range that is different to the mass-to-charge ratio of other ions produced from said sample;

(ii) separating the charged positive ions of the different isotopes of said at least two different elements according to their mass-to-charge ratios; (iii) determining at least one ratio of the different isotopes of said at least two different elements separated in step (ii).

A4. In the method of any one of A1 to A3, the at least one element, or the single element, may be selected from the group consisting of: hydrogen, oxygen, sulfur, nitrogen, carbon, silicon, helium, neon, argon, chlorine, uranium and combinations thereof.

A5. In the method of A1, A2 or A3, the ions may be multiply charged atomic positive ions.

A6. In the method of A1, A2, A3, A4 or A5, the multiply charged atomic positive ions may have a charge of +2 or +3.

A7. In the method of A1, A2, A3, A4, A5 or A6, wherein the at least one element, or the single element, may be selected from the group consisting of: oxygen, sulfur, nitrogen, and carbon.

A8. In the method of A1, A2, A3, A4, A5, A6 or A7, the sample may comprise one or more of the following compounds: water, carbon dioxide, carbon monoxide, methane, dinitrogen oxide, nitrogen monoxide, nitrogen dioxide, ammonia, sulfur dioxide, hydrogen sulphide, sulphur hexafluoride, chloromethane, tetrafluoromethane, tetrafluorosilane, oxygen, ozone and nitrogen.

A9. In the method of A1, A2, A3, A4, A5, A6 A7, or A8, the method may comprise determining between one and six isotope ratios of a single element.

A10. In the method of A9, the single element may be selected from the group consisting of: hydrogen, oxygen, sulfur, nitrogen, carbon, silicon, helium, neon, argon, chlorine, uranium and combinations thereof.

A11. In the method of A9, the ions may be multiply charged atomic positive ions.

A12. In the method of A11, the multiply charged atomic positive ions may have a charge of +2 or +3.

A13. In the method of A11 or A12, the at least one element may be selected from the group consisting of: oxygen, sulfur, nitrogen, and carbon.

A14. In the method of A11, A12 or A13, the method may comprise determining at least one ratio selected from the group consisting of: ¹⁸O/¹⁶O, ¹⁸O/¹⁷O, ¹⁷O/¹⁶O, ¹³C/¹²C, ¹⁵N/¹⁴N, ³³S/³²S, ³⁴S/³²S, ³⁶S/³²S, ³³S/³⁴S, ³³S/³⁶S, and ³⁴S/³⁶S.

A15. The method of A11, A12, A13 or A14, wherein the method may comprise determining at least one ratio selected from the group consisting of: ¹⁸O/¹⁶O, ¹⁸O/¹⁷O, ¹⁷O/¹⁶O, ¹³C/¹²C and ¹⁵N/¹⁴N.

A16. The method of A11, A12, A13, A14 or A15, wherein the method comprises determining at least one ratio selected from the group consisting of: ¹⁸O/¹⁶O, ¹⁸O/¹⁷O and ¹⁷O/¹⁶O.

A17 In the method of any one of A9 to A16, the sample may comprise one or more of the following compounds: water, carbon dioxide, carbon monoxide, methane, dinitrogen oxide, nitrogen monoxide, nitrogen dioxide, ammonia, sulfur dioxide, hydrogen sulphide, sulphur hexafluoride, chloromethane, tetrafluoromethane, tetrafluorosilane, oxygen, ozone and nitrogen.

A18. In the method of any one of A1 to A17, the method may comprise determining two or three ratios of different isotopes of two, three or four different elements.

A19. In the method of any one of A1 to A18, the method may comprise determining one ratio of different isotopes of two different elements.

A20. In the method of A18 or A19, wherein the at least two or three different elements may be selected from the group consisting of: hydrogen, oxygen, sulfur, nitrogen, carbon, silicon, helium, neon, argon, chlorine, uranium and combinations thereof.

A21. In the method of A18 or A19, the ions may be multiply charged positive ions.

A22. In the method of A18, A19, A20 or A21, the at least two different elements may be selected from the group consisting of: oxygen, sulfur, nitrogen, and carbon.

A23. In a second aspect, the present invention provides an isotope ratio mass spectrometer apparatus comprising:

(i) an ion source capable of producing a beam of multiply charged atomic positive ions and single charged positive ions for hydrogen and single charged positive ions for deuterium;

(ii) a primary analyser adapted to separate said charged positive ions according to their mass-to-charge ratios;

(iii) at least one ion detector to detect said separated charged positive ions.

A24. In the apparatus of A23, the ion source may be an electron cyclotron resonance (ECR) source.

A25. In the apparatus of A23 or A24, the charged positive ions may be multiply charged atomic positive ions.

A26. In the apparatus of A23, A24 or A25, the primary analyzer may be selected from the group consisting of: a sector field magnet, a Wein filter, a quadrupole mass filter and a time-of-flight measurement system.

A27. The apparatus of A23, A24, A25 or A26, may comprise an additional analyzer.

A28. In the apparatus of A23, A24, A25, A26 or A27, wherein the at least one detector may be a Faraday cup.

A29. In a third aspect, the present invention provides an isotope ratio mass spectrometer apparatus comprising:

(i) an ion source capable of producing a beam of multiply charged atomic positive ions and single charged positive ions for hydrogen and single charged positive ions for deuterium;

(ii) a primary analyser adapted to separate said charged positive ions according to their mass-to-charge ratios;

(iii) at least two ion detectors to detect said separated charged positive ions.

A30. In the apparatus of A29, the ion source may be an electron cyclotron resonance (ECR) source.

A31. In the apparatus of claim A29 or A30, the charged positive ions may be multiply charged atomic positive ions.

A32. In the apparatus of any one of A29 to A31, the primary analyzer may be selected from the group consisting of: a sector field magnet, a Wein filter, a quadrupole mass filter and a time-of-flight measurement system.

A33. The apparatus of any one of A29 to A32, may comprise an additional analyzer.

A34. The apparatus of any one of A29 to A33, wherein the at least two detectors may be Faraday cups.

### DETAILED DESCRIPTION OF THE INVENTION

The present invention provides a method for determining at least one ratio of different isotopes of at least one element in a sample said method comprising:

(i) ionizing the sample to produce ions of the different isotopes of said at least one element, said ions being selected from the group consisting of: multiply charged atomic positive ions, single charged positive ions for hydrogen and single charged positive ions for deuterium;

(ii) separating the charged positive ions of the different isotopes of said at least one element according to their mass-to-charge ratios; and

The method may involve determining at least one ratio of the different isotopes of said at least one element separated in step (ii).

The method may comprise ionizing the sample to produce ions of the different isotopes of said at least one element, said ions being multiply charged atomic positive ions.

The method may comprise detecting multiply charged atomic positive ions.

The positive ions may be singly charged where it is desired to determine the ratio of hydrogen and deuterium isotopes, (for example ²H/¹H). Where it may be desired to determine the ratio of isotopes wherein at least one isotope is hydrogen or deuterium (for example ¹⁸O/²H or ¹³C/¹H), the charged positive ions may be singly charged and multiply charged.

The method may comprise determining at least one ratio of the different isotopes of said at least one element separated in step (ii) from singly charged positive ions and multiply charged atomic ions produced from said ionizing.

The method may comprise determining the ratio of different isotopes of 2, 3, 4, 5, 6, 7, 8, 9, 10 or more elements.

The method may comprise determining the ratio of different isotopes of the same element, for example the ratio of ¹⁸O/¹⁶O, or alternatively the method may comprise simultaneously determining the ratios of pairs of isotopes of different elements in the same sample, for example the ratios ¹³C/¹²C, ¹⁷O/¹⁶O and ¹⁸O/¹⁶O in carbon dioxide.

The method may comprise determining two ratios of different isotopes of the same element, for example ¹⁸O/¹⁶O and ¹⁸O/¹⁷O, or alternatively the method may comprise determining two ratios of different isotopes of different elements, for example ¹⁸O/¹⁴N and ¹⁷O/¹³C.

The at least one ratio of different isotopes may be determined by calculating the ratio of measured parameters which are proportional to the relative amounts of the different isotopes of the at least one element present in a sample. For example, the measured parameter may be current or number of ions detected per unit time. In one embodiment the measured parameters are currents generated by the detection of multiply charged atomic positive ions having different mass-to-charge ratios.

The method may comprise determining any one or more of the following isotope ratios: ¹⁸O/¹⁶O, ¹⁸O/¹⁷O, ¹⁷O/¹⁶O, ¹³C/¹²C, ¹⁵N/¹⁴N, ³³S/³²S, ³⁴S/³²S, ³⁶S/³²S, ³³S/³⁴S, ³³S³⁶S, ³⁴S/³⁶S.

The at least one element may be any element that is capable of forming multiply charged positive ions. For example, the at least one element may be selected from the group consisting of: carbon, nitrogen, oxygen, sulfur, helium, neon, argon, chlorine, silicon, uranium and other elements. The method may comprise determining any one or more of the following isotope ratios: ³He/⁴He, ²¹Ne/²⁰Ne, ²²Ne/²⁰Ne, ³⁶Ar/⁴⁰Ar, ³⁸Ar/⁴⁰Ar ³⁷Cl/³⁵Cl, ²⁹Si/²⁸Si, ³⁰Si/²⁸Si, ²³⁴U/²³⁸U, ²³⁵U/²³⁸U or other isotopic ratios.

Step (i) may comprise ionizing the sample with an ion source capable of producing multiply charged positive ions, for example a gas discharge ion source such as a Penning ion gauge (PIG) source or duoplasmatron, a high density plasma source such as a laser plasma or MEVVA source, a radio frequency (RF) ion source such as an inductively coupled plasma (ICP) ion source, a microwave ion source such as an electron cyclotron resonance (ECR) source. Other specific examples of suitable ion sources are an electron beam ion source (EBIS), an electron impact (EI) source, a secondary ion (sputter) source, or arc-based sources such as the Bernas source, Freeman source or Calutron.

The multiply charged atomic positive ions may have a charge of +2, +3, +4, +5, +6, +7, or greater.

The charged positive ions may be separated by use of a sector field magnet either in the form of an electromagnet or a permanent magnet, a quadrupole mass filter, a Wien filter or a time-of-flight spectrometer.

The sample may comprise chemical elements, organic compounds, inorganic compounds or a mixture thereof, in gas, liquid, plasma, solid or mixed phase form. In one embodiment the sample may not comprise a mixture of compounds. In one embodiment the compound may be selected from the group consisting of: carbonates, sulfates, nitrates oxides and hydrated minerals. More specific examples may include: water, carbon dioxide, carbon monoxide, methane, dinitrogen oxide, nitrogen monoxide, nitrogen dioxide, ammonia, sulfur dioxide, hydrogen sulphide, sulphur hexafluoride, chloromethane, tetrafluoromethane, tetrafluorosilane, oxygen, ozone and nitrogen.

The multiply charged atomic positive ions separated in step (ii) may have a mass-to-charge ratio of between 1 to about 120, about 2 to about 80, about 2 to about 35, about 2 to about 18, about 3 to about 16, about 4 to about 12, about 5 to about 11 or about 6 to about 10.

The multiply charged atomic positive ions may be atomic ions of any element that is capable of forming multiply charged atomic positive ions. In one embodiment the multiply charged atomic positive ions may be ions of elements selected from the group consisting of: carbon, nitrogen, oxygen, sulfur, helium, neon, argon, chlorine, silicon, uranium and other elements. For example the atomic ions may be selected from the group consisting of: ¹²C²⁺, ¹³C²⁺, ¹⁴N²⁺, ⁵N²⁺, ¹⁶O²⁺, ¹⁷O²⁺, ¹⁸O²⁺, ³²S³⁺, ³³S³⁺, ³⁴S³⁺ and ³⁶S³⁺.

The method of the invention may comprise ionizing the sample to produce singly charged positive ions of one element, in addition to multiply charged atomic positive ions of at least one other element.

The method of the invention may comprise determining at least one ratio of different isotopes of the same element or different elements separated in step (ii), wherein at least one of the isotopes separated in step (ii) is multiply charged. For example, where the sample is water the method may comprise determining at least one ratio selected from the group consisting of: ¹⁸O/¹⁶O, ¹⁸O/¹⁷O, ¹⁷O/¹⁶O, ¹⁸O/²H, ¹⁸O/¹H, ¹⁷O/²H, ¹⁷O/¹H, ¹⁶O/²H and ¹⁶O/¹H.

The method of the invention allows determination of the ratios of hydrogen isotopes and/or the ratios of isotopes of another element or elements from a group which may include oxygen, carbon, sulfur or nitrogen simultaneously from a single sample injection into the ion source.

According to an embodiment of the invention, there is provided a method for determining at least one ratio of different isotopes of at least two different elements in a sample said method comprising:

(i) ionizing the sample to produce ions of the different isotopes of said at least two different elements, said ions being selected from the group consisting of: multiply charged atomic positive ions, single charged positive ions for hydrogen and single charged positive ions for deuterium, wherein the mass-to-charge ratios of the charged positive ions of the different isotopes are in a mass-to-charge ratio range that is different to the mass-to-charge ratio of other ions produced from said sample;

(ii) separating the charged positive ions of the different isotopes of said at least two different elements according to their mass-to-charge ratios;

(iii) determining at least one ratio of the different isotopes of said at least two different elements separated in step (ii).

The charged positive ions may be multiply charged. Alternatively, the charged positive ions may be singly charged. In another embodiment the charged positive ions may be singly charged and multiply charged.

The method may comprise determining the ratio of different isotopes of 2, 3, 4, 5, 6, 7, 8, 9, 10 or more elements.

The at least two different elements may be any elements that are capable of forming multiply charged atomic positive ions. For example, the at least two different elements may be selected from the group consisting of: carbon, nitrogen, oxygen, sulfur, helium, neon, argon, krypton, xenon, chlorine, bromine, silicon, uranium and other elements.

The method may comprise determining one ratio of different isotopes of two different elements, for example the ratio of ¹⁸O/¹³C, or alternatively the method may comprise determining two ratios of different isotopes of two or three different elements, for example ¹⁸O/¹³C and ¹⁷O/¹²C, or ¹⁸O/¹³C and ¹⁶O/⁴N.

The other ions produced from said sample may be atomic ions, molecular ions or a mixture thereof. The mass-to-charge ratio of the multiply charged atomic positive ions of the isotopes may be in a range of between 1 to about 120, about 2 to about 80, about 2 to about 35, about 2 and about 18, about 3 to about 16, about 4 to about 12, about 5 to about 11 or about 6 to about 10.

The multiply charged atomic positive ions may be atomic ions of any element that is capable of forming multiply charged atomic positive ions. In one embodiment the multiply charged atomic positive ions may be ions of elements selected from the group consisting of: carbon, nitrogen, oxygen, sulfur, helium, neon, argon, chlorine, silicon, uranium and other elements. For example the multiply charged atomic positive ions may be selected from the group consisting of: ¹²C²⁺, ¹³C²⁺, ¹⁴N²⁺, ¹⁵N²⁺, ¹⁶O²⁺, ¹⁷O²⁺, ¹⁸O²⁺, ³²S³⁺, ³³S³⁺, ³⁴S³⁺ and ³⁶S³⁺.

According to another embodiment of the invention there is provided a method for determining at least one ratio of different isotopes of an element in a sample said method comprising:

(i) ionizing the sample to produce ions of the different isotopes of the element, said ions being selected from the group consisting of: multiply charged atomic positive ions, single charged positive ions for hydrogen and single charged positive ions for deuterium wherein the mass-to-charge ratios of the charged positive ions of the different isotopes are in a mass-to-charge ratio range that is different to the mass-to-charge ratio of other ions produced from said sample;

(ii) separating the charged positive ions of the different isotopes of the element according to their mass-to-charge ratios; and

(iii) determining at least one ratio of the different isotopes of the element separated in step (ii).

The method may comprise determining a single isotope ratio of a single element, or the method may comprise determining two isotope ratios of a single element, or the method may comprise determining three isotope ratios of a single element, or the method may comprise determining four isotope ratios of a single element.

The method may comprise determining between 1 and 3 isotope ratios of a single element, or between 1 and 4 isotope ratios of a single element, or between 1 and 5 isotope ratios of a single element, or between 1 and 6 ratios of a single element, or between 1 and 7 ratios of a single element, or between 1 and 8 ratios of a single element, or between 1 and 9 ratios of a single element, or between 1 and 10 ratios of a single element.

The charged positive ions may be multiply charged. Alternatively, the charged positive ions may be singly charged where it is desired to determine the ratios of hydrogen and deuterium isotopes.

In one embodiment, the element may be any element that is capable of forming multiply charged atomic positive ions. For example, the element may be selected from the group consisting of: carbon, nitrogen, oxygen, sulfur, helium, neon, argon, chlorine, silicon, uranium and other elements.

In one embodiment the element may be selected from the group consisting of: carbon, nitrogen, oxygen and sulfur.

The multiply charged atomic positive ions separated in step (ii) may have a mass-to-charge ratio between about 4 and about 14, about 4 and about 12, about 4 and about 10, about 4 and about 9, about 5 and about 14, about 5 and about 12, about 5 and about 10, or about 5 and about 9.

The multiply charged atomic positive ions may be selected from the group consisting of: ¹²C²⁺, ¹³C²⁺, ¹⁴N²⁺, ¹⁵N²⁺, ¹⁶O²⁺, ¹⁷O²⁺, ¹⁸O²⁺, ³²S³⁺, ³³S³⁺, ³⁴S³⁺ and ³⁶S³⁺.

The method may comprise determining one ratio of different isotopes of the element, for example the ratio of ¹⁸O/¹⁶O, or alternatively the method may comprise determining two or three ratios of different isotopes of the element, for example ¹⁸O/¹⁶O and ¹⁸O/¹⁷O, or ¹⁸O/¹⁶O, ¹⁷O/¹⁶O and ¹⁸O/¹⁷O.

The other ions produced from said sample may be atomic ions, molecular ions or a mixture thereof.

The method of the invention may not include the step of converting multiply charged atomic positive ions to single charged positive ions prior to said step of determining at least one ratio.

The method may not include the step of decelerating the charged atomic positive ions prior to said step of determining at least one ratio.

The method may not include the steps of converting multiply charged atomic positive ions to single charged positive ions, and decelerating the charged atomic positive ions prior to said step of determining at least one ratio.

The method of the invention may not include the combination of the following steps:

(i) ionizing the sample to produce a beam of multiply charged positive ions;

(ii) selection of a portion of the beam of multiply charged positive ions having a predetermined mass range;

(iii) accelerating the beam into a gas cell so as to convert the multiply charged positive ions to singly charged positive ions;

(iv) deceleration of the singly charged positive ions;

(v) selection of singly charged positive ions having a predetermined energy;

(vi) selection of singly charged positive ions having a predetermined mass; and

(vii) detection of the singly charged positive ions.

The present invention also provides an isotope ratio mass spectrometer apparatus comprising:

(i) an ion source capable of producing a beam of multiply charged atomic positive ions and single charged positive ions for hydrogen and single charged positive ions for deuterium;

(ii) a primary analyser adapted to separate said charged positive ions according to their mass-to-charge ratios;

(iii) at least one ion detector to detect said separated charged positive ions.

The charged positive ions may be multiply charged. Alternatively, the charged positive ions may be singly charged. In another embodiment the charged ions may be multiply and singly charged.

The ions detected may be multiply charged atomic positive ions.

The apparatus may not include means for converting the charge of the multiply charged atomic positive ions to +1.

The apparatus may not include means for decelerating the charged positive ions.

The apparatus may not include a gas cell comprising a knock-on gas such as argon for converting the charge of the multiply charged ions to +1.

The apparatus may not include means for converting the charge of the multiply charged atomic positive ions to +1, and also may not include means for decelerating the charged positive ions.

The ion source may be any ion source that is capable of producing multiply charged atomic positive ions. The ion source may be selected from the group consisting of: a gas discharge ion source such as a Penning ion gauge (PIG) source or duoplasmatron, a high density plasma source such as a laser plasma or MEVVA source, a radio frequency (RF) ion source such as an inductively coupled plasma (ICP) ion source, a microwave ion source such as an electron cyclotron resonance (ECR) source. Other specific examples of suitable ion sources are an electron beam ion source (EBIS), an electron impact (EI) source, a secondary ion (sputter) source, or arc-based sources such as the Bernas source, Freeman source or Calutron.

In an alternative embodiment a microwave source such as an ECR source may be used in conjunction with another ion source, such as a gas discharge ion source or an RF ion source,

wherein the ECR source acts as a charge state multiplier. For example an ICP source can be used to generate singly charged ions which are injected into an ECR ion source whereby the singly charged ions are converted to multiply charged ions.

The multiply charged atomic positive ions may have a charge of +2, +3, +4, +5, +6, +7, or greater.

The multiply charged atomic positive ions separated in step (ii) may have a mass-to-charge ratio of between 1 to about 120, about 2 to about 80, about 2 to about 35, about 2 to about 18, about 3 to about 16, about 4 to about 12, about 5 to about 11 or about 6 to about 10.

The multiply charged atomic positive ions may be selected from the group consisting of: carbon, nitrogen, oxygen, sulfur, helium, neon, argon, krypton, xenon, chlorine, bromine, silicon, uranium and other elements. For example the multiply charged atomic positive ions may be selected from the group consisting of: ¹²C²⁺, ¹³C²⁺, ¹⁴N²⁺, ¹⁵N²⁺, ¹⁶O²⁺, ¹⁷O²⁺, ¹⁸O²⁺, ³²S³⁺, ³³S³⁺, ³⁴S³⁺ and ³⁶S³⁺.

The primary analyser may be a sector field magnet, either in the form of an electromagnet, or in the form of a permanent magnet. Alternatively, the primary analyser may be selected from the group consisting of a Wien filter, a quadrupole mass filter and a time-of-flight measurement system.

The primary analyser may be configured to separate multiply charged atomic positive ions in space or in time.

The apparatus may additionally comprise at least one additional analyser.

The additional analyser may be selected from the group consisting of: an electrostatic analyzer or an energy filter, such as a retarding lens.

An additional analyser may be disposed downstream of the ion source and upstream of the primary analyser. Alternatively, the additional analyser may be disposed downstream of the primary analyser. The apparatus may comprise a plurality of additional analysers.

The primary and additional analysers may also comprise focusing properties to enhance the efficiency of ion beam transport therethrough. For example, a sector field magnet may incorporate design features which enable simultaneous vertical and horizontal focussing of the beam of positive ions. Similarly, where the additional analyser is an electrostatic analyser design features which enable vertical and/or horizontal focussing of the beam may be included. Alternatively, the combination of certain designs of primary and additional analysers may be used to achieve desired beam focusing properties. For example, an electrostatic analyser may be combined with a sector field magnet in Nier-Johnson geometry.

The apparatus may additionally comprise ion beam transport means adapted to focus and transmit the beam of positive ions to the at least one detector.

The ion beam transport means may comprise: an Einzel lens, an electrostatic multipole, a magnetic multipole or a magnetic solenoid, or combinations thereof.

The ion beam transport means may also comprise steerers adapted to guide the beam of positive ions. Suitable steerers may be electrostatic or magnetic steerers.

The ion beam transport means may be disposed downstream of the ion source.

The at least one ion detector may be selected from the group consisting of: a secondary electron multiplier detector operating in ion counting or current measuring mode, for example a Channeltron or a discrete dynode electron multiplier or a microchannel plate, a Daly detector, a Faraday cup, or a combination of the above detectors.

The at least one detector may not be a mass spectrometry system with Mattauch-Herzog geometry with ion detection system.

The apparatus may comprise an array of two, three, four, five or more ion detectors. Where it is desired to determine one ratio of different isotopes (for example ¹⁷O/¹⁶O), two detectors may be used. Where it is desired to determine two ratios of different isotopes wherein one isotope is common to both determinations (for example, ¹⁷O/¹⁶O and ¹⁸O/¹⁶O where ¹⁶O is common to both determinations), three detectors may be used. Where it is desired to determine two ratios of different isotopes wherein no isotope is common to both determinations (for example, ¹⁸O/¹⁶O and ¹³C/¹²C), four detectors may be used. Alternatively, in all of the above examples a single detector may be used.

The at least one ion detector may be disposed downstream of the primary analyser, or downstream of the additional analyser.

The at least one ion detector may be coupled to a processor. The processor may be configured to determine at least one ratio of different isotopes of least one element by calculating the ratio of measured parameters which are proportional to the relative amounts of the different isotopes of the at least one element present in a sample. For example, the measured parameter may be current or number of ions detected per unit time. The processor may be a computer.

### BRIEF DESCRIPTION OF THE DRAWINGS

A preferred form of the present invention will now be described by way of example with reference to the accompanying drawings wherein:

FIGS. 1 and 2 illustrate an isotope ratio mass spectrometer in accordance with embodiments of the invention.

FIG. 3 shows the results of a determination of the ratios of ¹⁶O, ¹⁷O and ¹⁸O in a sample of water vapour at a charge state of +1 and +2.

### DETAILED DESCRIPTION OF THE PREFERRED EMBODIMENTS

The present invention is directed to an isotope ratio mass spectrometer apparatus comprising: an ion source capable of producing a beam of multiply charged atomic positive ions and single charged positive ions for hydrogen and single charged positive ions for deuterium; a primary analyser adapted to separate said charged positive ions according to their mass-to-charge ratios; at least one ion detector to detect said separated charged positive ions, and at least one ion detector to detect said separated charged positive ions.

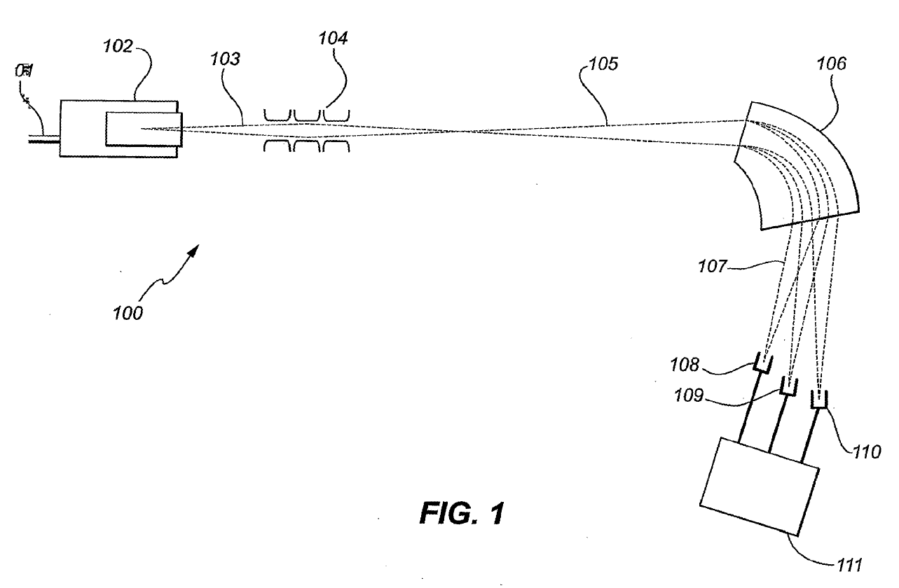

FIG. 1 shows an isotope ratio mass spectrometer apparatus 100 in accordance with one embodiment of the invention which may be used for determining at least one ratio of different isotopes of at least one element in a sample. Apparatus 100 comprises ion source 102, which is capable of producing a beam of positive ions 103 including multiply charged atomic positive ions. Apparatus 100 also comprises an injection port 101 for introduction of the sample, and a vacuum housing (not shown). Ion source 102, which is typically an ECR ion source, produces a beam of positive ions including multiply charged atomic positive ions 103. Alternatively, ion source 102 may be a gas discharge ion source such as a Penning ion gauge (PIG) source or duoplasmatron, a high density plasma source such as a laser plasma or MEVVA source, a radio frequency (RF) ion source such as an inductively coupled plasma (ICP) ion source, or a microwave ion source. Other specific examples of suitable ion sources are an electron beam ion source (EBIS), an electron impact (EI) source, a secondary ion (sputter) source, or arc-based sources such as the Bernas source, Freeman source or Calutron. The multiply charged atomic positive ions typically have a charge of +2, but may have a charge of +3, +4, +5, +6, +7 or greater. Ion source 102 is typically tuned to produce a charge state of +2, which allows analysis of atomic ions without interference from molecular ions, and possibly other atomic ions, although alternative charge states may be required depending on the element or elements for as which ratios are to be determined. Where ion source 102 is an ECR ion source, the source may be tuned to enhance higher or lower charge states by adjusting the pressure in the ion source, or the microwave power. Other parameters of the ECR ion source that may be adjusted in order to enhance higher or lower charge states are: the magnetic field strength, the microwave frequency, the position of the magnets relative to the beam extraction system or the incorporation of a biased electrode which influences charge state distribution. Those skilled in the art will be familiar with the operation of an ECR ion source in the context of controlling the charge state (see for example R. Geller, Electron Cyclotron Resonance Ion Sources and ECR Plasmas, IOP Publishing, Bristol, 1996.) Ion beam 103 is incident upon ion beam transport means 104 which is disposed downstream of said ion source 102. Ion beam transport means 104 focuses and transmits the positive ion beam 105 to the primary analyser 106. Primary analyser 106 is adapted to separate multiply charged atomic positive ions according to their mass-to-charge ratios, thereby generating a plurality of ion beams 107, each of which comprises multiply charged atomic positive ions having different mass-to-charge ratios. The separation may be achieved by use of a sector field magnet, for example an electromagnet whereby the constituent multiply charged atomic positive ions of the ion beam are deflected by a magnetic field generated by the electromagnet in an amount that is dependent on the mass-to-charge ratio of the multiply charged atomic positive ions. The multiply charged atomic positive ions separated by selector 106 may have a mass-to-charge ratio of between about 2 and about 18, about 3 and about 16, about 4 and about 12, about 5 and about 11, or about 6 and about 10. The multiply charged atomic positive ions separated may be selected from the group consisting of: ¹²C²⁺, ¹³C²⁺, ¹⁴N²⁺, ¹⁵N²⁺, ¹⁶O²⁺, ¹⁷O²⁺, ¹⁸O²⁺, ³²S³⁺, ³³S³⁺, ³⁴S³⁺ and ³⁶S³⁺. The separated multiply charged atomic positive ions 107 emerging from the selector 106 are detected by ion detectors 108 to 110. The detectors 108 to 110 may be selected from the group consisting of: a secondary electron multiplier detector operating in ion counting or current measuring mode, for example a Channeltron or a discrete dynode electron multiplier or a microchannel plate, a Daly detector, a Faraday cup or a combination of the above detectors. A typical Faraday cup is a metal cup with razor blade-like structures defining an entrance into the cup. Detectors 108 to 110 detect the separated multiply charged atomic positive ions and transmit information to processor 111. Processor 111 may be configured to calculate and output or display on a screen at least one ratio of different isotopes of at least one element.

In use to determine at least one ratio of different isotopes of at least one element in a sample using the apparatus of FIG. 1, a gaseous sample is introduced into ion source 102 via injection port 101. The gaseous sample may be an element, an organic compound, an inorganic compound or a mixture thereof. At least the element or elements for which isotope ratios are to be determined in the gaseous sample is/are ionised by the ion source to form multiply charged positive atomic ions of the different isotopes of the at least one element. Positive ion beam 103 emerges from source 102. Ion beam 103 is focused and subsequently transmitted to the primary analyser 106 which may be a sector field electromagnet, for example, which is disposed downstream of source 102. Selector 106 separates the multiply charged atomic positive ions of the different isotopes of the at least one element according to their mass-to-charge ratios, and the separated multiply charged positive atomic ion beams 107 are then transmitted to ion detectors 108 to 110, which are typically Faraday cups. Detectors 108 to 110 transmit information to processor 111. Multiply charged atomic positive ions collected in the detectors are measured as electrical currents flowing from the respective detectors. The magnitude of the current is proportional to the relative amount of multiply charged atomic positive ions detected by the detector. The current is measured by high sensitivity ammeters in communication with the detector, with processor 111 reading the current. The at least one ratio of different isotopes is then calculated by the processor 111 from the ratio of the currents from the respective ammeters, or alternatively from the ratio of sequential current readings from the same ammeter if a single detector is being used. Alternatively, where the detectors 108 to 110 are secondary electron multipliers, such as a Daly detectors, channeltrons or microchannel plates, multiply charged atomic positive ions collected in the detectors 108 to 110 may be measured by the ion counting rate, that is, the number of ions detected per unit time. This involves counting pulses from the detectors 108 to 110, with each pulse corresponding to the arrival of one individual ion.

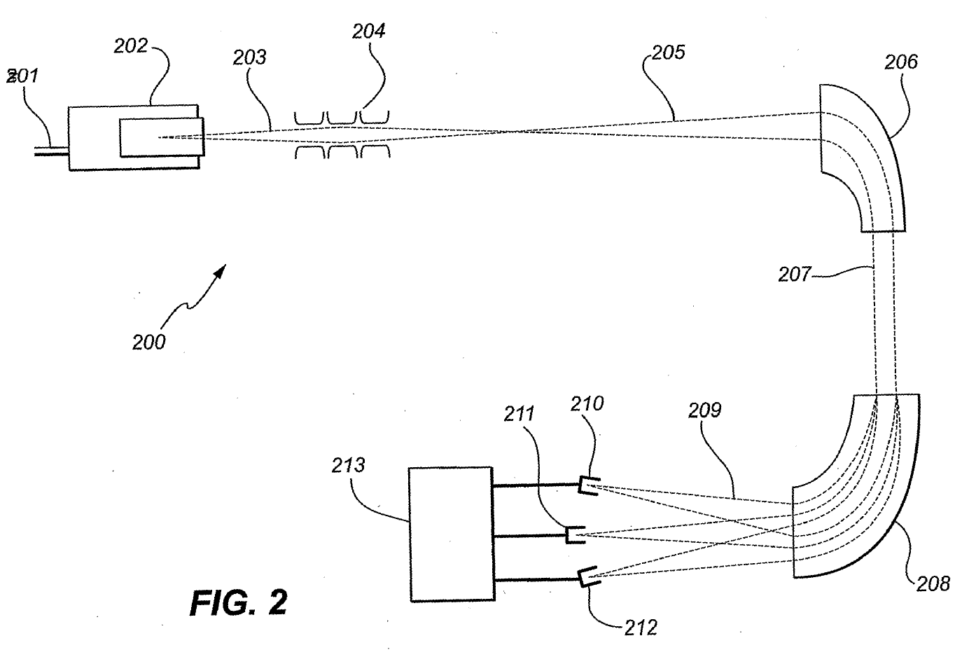

FIG. 2 shows an alternative embodiment of an isotope ratio mass spectrometer 200 in accordance with the invention which may be used for determining at least one ratio of different isotopes of at least one element in a sample. Apparatus 200 comprises ion source 202, which is capable of producing a beam of positive ions 203 including multiply charged atomic positive ions. Ion source 202 comprises injection port 201 for introduction of a sample. Apparatus 200 also comprises a vacuum housing (not shown). Ion source 202 which is typically an ECR ion source, but may be a gas discharge ion source such as a Penning ion gauge (PIG) source or duoplasmatron, a high density plasma source such as a laser plasma or MEVVA source, a radio frequency (RF) ion source such as an inductively coupled plasma (ICP) ion source, an electron beam ion source (EBIS), an electron impact (EI) source, a secondary ion (sputter) source, or an arc-based source such as the Bernas source, Freeman source or Calutron, produces a beam of positive ions including multiply charged atomic positive ions 203 which is incident upon ion beam transport means 204 which is disposed downstream of said ion source 202. Ion beam transport means 204 focuses and transmits the positive ion beam 205 to additional analyser 206, which is typically an electrostatic analyser that selects positive ions according to their energy-to-charge ratio. Additional analyser 206 is disposed upstream of primary analyser 208. Ion beam 207 exits additional analyser 206 and is incident on primary analyser 208 which is adapted to separate the multiply charged atomic positive ions according to their mass-to-charge ratios. The separated multiply charged atomic positive ions 209 emerging from the primary analyser 208 are detected by ion detectors 210 to 212, which transmit information to processor 213. The isotopic ratio is then determined by the processor 213 in the same manner as described above in connection with the apparatus shown in FIG. 1.

In use to determine at least one ratio of different isotopes of at least one element in a sample using the apparatus of FIG. 2, a gaseous sample is introduced into ion source 202 via injection port 201. The gaseous sample may be an element, an organic compound, an inorganic compound or a mixture thereof. At least the element or elements for which isotope ratios are to be determined in the gaseous sample is/are ionised by the ion source to form multiply charged atomic positive ions of the different isotopes of the at least one element. Ion beam 203 emerges from source 202. Ion beam 203 is focused and subsequently transmitted to the additional analyser 206, which may be an electrostatic analyser, which is disposed downstream of source 202. Ion beam 207 exits additional analyser 206 and is incident on primary analyser 208 which separates the multiply charged positive atomic ions of the different isotopes of the at least one element according to their mass-to-charge ratios, and the separated atomic ion beams 209 are then transmitted to ion detectors 210 to 212 which transmit information to processor 213. The isotopic ratio is then determined by the processor 213 in the same manner as described above in connection with the use of the apparatus shown in FIG. 1.

The present invention is also directed to a method for determining at least one ratio of different isotopes of at least one element in a sample said method comprising: ionizing the sample to produce ions of the different isotopes of said at least one element, said ions being selected from the group consisting of: multiply charged atomic positive ions, single charged positive ions for hydrogen and single charged positive ions for deuterium; separating the charged positive ions of the different isotopes of said at least one element according to their mass-to-charge ratios; and determining at least one ratio of the different isotopes of said at least one element separated above.

Where it is desired to determine isotope ratios where one of the isotopes is hydrogen or deuterium, singly charged positive ions of hydrogen and deuterium are used.

As noted above, the sample may be ionized by use of any ion source that is capable of producing multiply charged atomic positive ions. The ion source may be selected from the group consisting of: a gas discharge ion source such as a Penning ion gauge (PIG) source or duoplasmatron, a high density plasma source such as a laser plasma or MEVVA source, a radio frequency (RF) ion source such as an inductively coupled plasma (ICP) ion source, a microwave ion source such as an electron cyclotron resonance (ECR) source. Other specific examples of suitable ion sources are an electron beam ion source (EBIS), an electron impact (EI) source, a secondary ion (sputter) source, or arc-based sources such as the Bernas source, Freeman source or Calutron.

Typically the ion source is an ECR source, as these ion sources have high ionization efficiencies, meaning that the method of the first aspect may be successfully used where the sample amount is as little as 1-100 ng.

The multiply charged atomic positive ions may have a charge of +2, +3, +4, +5, +6, +7, or greater. Typically, the multiply charged atomic ions have a charge of +2. Typically, the element is selected from the group consisting of: carbon, nitrogen, oxygen and sulfur.

By generating multiply charged atomic ions of the isotopes, the method of the first aspect allows the detection of atomic ions that are free from molecular interferences or ambiguities. The method is useful for determining the ratios of any isotopes, and even radioisotopes, of any element where molecular interferences need to be eliminated.

In the method of the first aspect the ratio of the isotopes is typically determined by a processor, for example a computer, which is operatively associated with the one or more detectors. Typically, the at least one ratio may be determined by calculating the ratio of parameters, for example ion current, which are proportional to the relative amounts of multiply charged atomic positive ions of the different isotopes present in a sample.

Where a plurality of Faraday cups are used as the detectors, ions collected in each Faraday cup are measured by an ammeter as an electrical current flowing from the detector. The magnitude of the current is proportional to the relative amount of ions detected by the Faraday cups. The at least one ratio of different isotopes is then calculated by the processor from the ratio of the currents from the respective ammeters. Where a single Faraday cup is used as the detector, the current is measured for a fixed period of time for each different isotope of interest in sequence. The at least one ratio of different isotopes is then calculated by the processor from the currents obtained from the ammeter as measured during each time period in the sequence. The current measurements may be repeated several times allowing the processor to calculate the average ratios. Multiple current measurements may be performed in order to average out ion source output variations which may affect the isotope ratios where sequential detection is employed.

In one embodiment of the first aspect, the method may be performed using either the apparatus depicted in FIG. 1 or FIG. 2 to determine the ratios of ¹⁷O/¹⁶O and ¹⁸O/¹⁶O in a sample without any sample preparation, such as converting the sample to pure oxygen gas, as is required by methods presently used for determining ¹⁷O ratios. The present method also eliminates the need for expensive sample processing equipment that is typically required when measuring oxygen isotopes. These deficiencies of known techniques (as well as the problem of interfering molecular ions mentioned above) are overcome by selecting the +2 charge state.

As indicated, in the method of the first aspect no sample preparation is necessary. All that is required is for the sample to be capable of being vapourised prior to introduction into the ion source. The sample may be water, CO₂, or any other organic or inorganic compound that is capable of being vapourised.

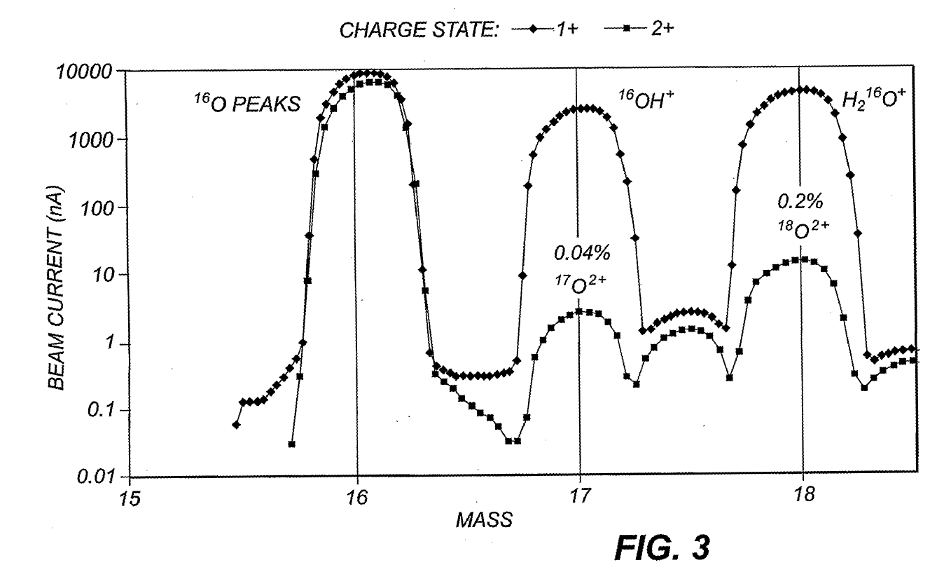

FIG. 3 shows the results of a determination of the ratios of ¹⁶O, ¹⁷O and ¹⁸O in a sample of water vapour at a charge state of +1 and also +2. When the +1 charge state is selected, mass 17 contains a contribution from the molecular species ¹⁶OH⁺, and also the atomic species ¹⁷O. Likewise, mass 18 contains a contribution from H₂¹⁶O⁺ and ¹⁸O. Owing to the very low natural abundances of ¹⁷O and ¹⁸O, and in view of the interference from the molecular species, ¹⁷O and ¹⁸O are not able to be accurately determined.

However, in accordance with the present method, when the +2 charge state is selected, it is seen from FIG. 3 that the interference resulting from the molecular species at mass 17 and 18 is completely eliminated enabling the ¹⁸O/¹⁶O and ¹⁷O/¹⁶O ratios to be accurately determined without interference from molecular species comprising oxygen and hydrogen. The present method offers the following advantages:
¹⁷O/¹⁶O isotope ratios can be determined with high precision without the need to convert the samples to pure oxygen gas.
¹⁸O/¹⁶O and ¹⁷O/¹⁶O isotope ratios can be determined directly in water samples without the need to convert the samples to CO₂.
¹⁸O/¹⁶O and ¹⁷O/¹⁶O isotope ratios can be determined directly in CO₂ samples.
By eliminating the need for sample preparation and using an ion source with high ionisation efficiency, a considerably smaller sample volume is required (approximately 1-100 ng).

By selecting the +2 charge state, isotopic ratios of carbon and nitrogen can also be determined without interference from molecular species such as ¹³C¹⁶O¹⁶O and ¹²C¹⁶O¹⁷O. For example, ¹³C/¹²C can be determined in CO₂ and other carbon-containing gases and vapours. In addition, the method is useful for the determination of ¹⁵N/¹⁴N in nitrogen gas and other nitrogen-containing gases and vapours, including oxides of nitrogen.

For determination of isotopic ratios of carbon, nitrogen and oxygen, selection of the +2 charge state results in all of the atomic ions produced having a mass-to-charge ratio of between about 6 and about 9 rendering them free of molecular interference from species such as ¹²CH, ¹³CH, ¹⁴NH, ¹⁵N, ¹⁶OH etc. which are not observed in the +2 charge state. Any organic compounds (and for that matter inorganic compounds) are compatible with the method provided that such compounds can be vapourised. Where it is desired to determining at least one ratio of different isotopes of at least one element in a solid or a solid present in a suspension, the sample may be vapourised prior to introduction into the ion source. This may be achieved by introducing the solid or suspension into an inductively coupled plasma, by laser ablation or heating in a variety of furnace types.

The present method also offers the advantage that the detection of atomic ions eliminates the need for the application of correction factors, which are currently required in present methods due to the detection of molecular ion mass peaks containing overlapping contributions from several isotopes.

In another embodiment, the present method may also be used to determine the ratio of different isotopes of sulfur, for example sulfur in the form of SO₂ gas, by selecting the +3 charge state which eliminates interferences such as ³²S by (¹⁶O₂)⁺ and ³²S²⁺ from ¹⁶O⁺. Where the +3 charge state of sulfur is chosen, the mass-to-charge ratio of ³²S, ³³S, ³⁴S and ³⁶S is in the range of about 10.67 to 12 which eliminates the possibility of interference from oxygen ions.

When the present method is used for determining ratios of other elements, it is necessary to select a charge state that will result in no molecular or atomic interferences with the element or elements whose isotopic ratios are to be determined. The selection of the charge state to be employed will be readily elucidated by one skilled in the art by routine trial and experimentation. However, more often than not a charge state of +2 will be suitable for most elements.

An example of how one would go about selecting a charge state is given below for silicon. There are 3 isotopes of silicon, ²⁸Si, ²⁹Si and ³⁰Si, with ²⁸Si being the most abundant (92%). If the sample was in a form that included hydrogen, then SiH would interfere with the determination of ²⁹Si. Also, where nitrogen gas from the air was present, interference between ²⁸Si²⁺ and ¹⁴N⁺ and also between ³⁰Si²⁺ and ¹⁵N⁺ would be expected. However, selection of the +3 charge state results in silicon isotopes having mass-to-charge ratios of 9.33, 9.67 and 10; thereby eliminating both atomic and molecular interferences.

The method of the present invention may also be used to determine at least two isotopic ratios of at least two different elements in the same sample. For example, in the case of CO₂, carbon and oxygen isotope ratios (¹³C/¹²C, ¹⁷O/¹⁶O and ¹⁸O/¹⁶O) can be determined concurrently in the same sample. Similarly, the ratios ¹⁵N/¹⁴N, ¹⁷O/¹⁶O and ¹⁸O/¹⁶O may be determined in nitrogen monoxide gas. The ratios ¹⁷O/¹⁶O, ¹⁸O/¹⁶O, ³³S/³²S, ³⁴S/³²S and ³⁶S/³²S may be determined in sulfur dioxide gas. In a further example, the ratios ¹³C/¹²C, ¹⁵N/¹⁴N, ¹⁷O/¹⁶O and ¹⁸O/¹⁶O may be determined simultaneously in a substance containing carbon, nitrogen and oxygen, such as nitrobenzene or other organic compounds.

The method may also be used to determine the relative abundance of at least two different elements in the same sample, for example the carbon-nitrogen ratio in an organic material.

As foreshadowed above, for the purpose of detection of the multiply charged atomic positive ions, a number of different detectors and detector arrangements may be used. In the present method, a single detector may be used in all isotope ratio determinations regardless of how many ratios it is desired to determine. Alternatively, one detector may be provided for each different isotope of interest.

Where a single detector is used, the primary analyser may be configured to separate the multiply charged atomic positive ions in time, rather than in space (as is the case where multiple detectors are used). A system with a sector field magnet and a single detector may be configured to operate in two possible ways, either by switching the magnetic field between the settings required to place each different isotope in the detector, or alternatively by modulating the energy of the beam of positive ions (usually via the ion source beam extraction voltage) to alternately transmit isotopes of different masses to the same detector. A single Faraday cup may be used in the apparatus shown in FIG. 1, with one collector only and a narrower sector field magnet.

Where a Wien filter is used as the primary analyser, either the magnetic or electrostatic fields of the filter may be switched, or the energy of the beam of positive ions may be modulated. Where a quadrupole mass filter is used as the primary analyser, these filters by their very nature only transmit a single isotope at a time, and are therefore always used in conjunction with a single detector. Further, where a time-of-flight system is employed, all of the isotopes are measured in a single timing detector.

As also foreshadowed above and exemplified, multiple detectors may also be used such that each detector detects a single isotope of interest. For example, where it is desired to determine the ratio of all isotopes in nitrobenzene, a total of seven detectors (e.g. Faraday cups) may be used.

Where multiple detectors are employed, combinations of different detectors may be included. For example Faraday cups may be used together with a Daly detector. Combinations of detectors may be useful when the intensity of the beam of positive ions is low. For some isotope combinations one isotope may be of high intensity and another of low intensity meaning that the detector can be selected on the basis of its sensitivity. However, for the isotopes that are envisaged to be of most interest (C, N, O and S), Faraday cups connected to ammeters provide good results.

The method of the present invention is capable of an enormous number of uses and applications, such as, but not limited to:
Determination of the following isotopic ratios of carbon, nitrogen, oxygen and sulfur isotopes in gas samples: ¹³C/¹²C, ¹⁵N/¹⁴N, ¹⁷O/¹⁶O, ¹⁸O/¹⁶O, ³³S/³²S and/or ³⁴S/³²S
Determination of ¹³C/¹²C in a sample of carbon dioxide
Determination of ¹⁷O/¹⁶O and/or ¹⁸O/¹⁶O in a sample of carbon dioxide
Determination of ¹⁷O/¹⁶O and/or ¹⁸O/¹⁶O in a sample of water
Determination of ¹⁷O/¹⁶O and/or ¹⁸O/¹⁶O in a sample of oxygen gas
Determination of ¹⁵N/¹⁴N in a sample of nitrogen gas
Determination of ¹⁵N/¹⁴N in a sample of gas consisting of oxides of nitrogen
Determination of ¹⁷O/¹⁶O and/or ¹⁸O/¹⁶O in a sample of gas consisting of oxides of nitrogen
Determination of ¹⁷O/¹⁶O and/or ¹⁸O/¹⁶O in a sample of sulfur dioxide gas
Determination of ³³S/³²S and/or ³⁴S/³²S in a sample of sulfur dioxide gas
Determination of ¹⁷O/¹⁶O and ¹⁸O/¹⁶O values in water samples for hydrology and climate change studies, where the water samples may be derived from groundwater, surface water, rainfall, vapour in the atmosphere, ice, snow, soil moisture, etc.
Determination of ²H/¹H, ¹⁷O/¹⁶O, and ¹⁸O/¹⁶O values in water samples for hydrology and climate change studies where the water samples may be derived from groundwater, surface water, rainfall, vapour in the atmosphere, ice, snow, soil moisture etc.
Determination of ¹³C/¹²C, ¹⁷O/¹⁶O and/or ¹⁸O/¹⁶O values in solid calcium carbonate or carbon dioxide derived from carbonate materials such as corals or speleothems for climate change studies
Determination of ¹⁷O/¹⁶O and ¹⁸O/¹⁶O values in samples of the solar wind trapped on a surface
Determination of ¹⁷O/¹⁶O and ¹⁸O/¹⁶O values in meteorite samples or other extra-terrestrial materials
Determination of ¹⁷O/¹⁶O and ¹⁸O/¹⁶O values in dissolved oxygen in ocean or fresh water to determine the biological productivity of the water
Determination of ¹⁵N/¹⁴N, ¹⁷O/¹⁶O and/or ¹⁸O/¹⁶O in a sample of gas consisting of oxides of nitrogen derived from nitrates to determine the origin of the nitrate material
Determination of ¹⁷O/¹⁶O, ¹⁸O/¹⁶O, ³³S/³²S and/or ³⁴S/³²S in a sample of solid barium sulfate or sulfur dioxide gas derived from sulfates to determine the origin of the sulfate material
Determination of ¹³C/²C, ¹⁵N/¹⁴N, ¹⁷O/¹⁶O, ¹⁸O/¹⁶O, ³³S/³²S and/or ³⁴S/³²S in samples of interest to forensic investigations to establish the origin of sample materials
Determination of ¹³C/¹²C, ¹⁵N/¹⁴N, ¹⁷O/¹⁶O, ¹⁸O/¹⁶O, ³³S/³²S and/or ³⁴S/³²S in samples of foodstuffs to establish the origin of such samples, for example to identify adulteration of foods
Determination of the isotopic ratios of carbon, nitrogen, oxygen and/or sulfur in a biological system into which artificial isotopic tracer(s) of carbon, nitrogen, oxygen and/or sulfur have been introduced.

In biological systems, to determine the absorption, distribution, metabolism and/or excretion pathway for a substance into which artificial isotopic tracer(s) has/have been introduced.
Determination of ¹³C/¹²C, ¹⁵N/¹⁴N, ¹⁷O/¹⁶O, ¹⁸O/¹⁶O, ³³S/³²S and/or ³⁴S/³²S in specific extracts of organic or other materials, separated by means such as gas or liquid chromatography, for applications such as those described above.

Because no sample preparation is required for the determination of oxygen isotope ratios in water using the present method, the method may also be used in conjunction with a device which is capable of vapourising a sample of ice, with the vapour subsequently being introduced into the ion source.

### Examples

The invention will now be described in more detail by way of illustration only, with respect to the following examples. The examples are intended to serve to illustrate the invention and should not be construed as limiting the generality of the disclosure of the description throughout the specification.

For the isotopic determination examples shown below, the apparatus comprised an ECR ion source, an Einzel lens, a sector field magnet as the primary analyser, and a single Faraday cup as the detector. The beam current of each isotope was measured sequentially in an ammeter and the measurement cycle was repeated either 3 or 4 times. The mean ratio of the currents was then evaluated and compared to the ratio expected from the known natural abundance. The measured value is expected to be close to the natural abundance, although it may not exactly match that value.

### Example 1

### Determination of Oxygen Isotope Ratios in Water Vapour

| Faraday cup readings | | | Ratio | Ratio |
|---|---|---|---|---|
| ¹⁶O²⁺ (nA) | ¹⁷O²⁺ (nA) | ¹⁸O²⁺ (nA) | ¹⁷O/¹⁶O (%) | ¹⁸O/¹⁶O (%) |
| 6060 | 2.34 | 12.56 | 0.03861 | 0.2073 |
| 6052 | 2.34 | 12.63 | 0.03866 | 0.2087 |
| 6065 | 2.35 | 12.62 | 0.03875 | 0.2081 |
| 6053 | 2.34 | 12.6 | 0.03866 | 0.2082 |
| 6050 | 2.35 | 12.62 | 0.03884 | 0.2086 |
| | | Mean | 0.03871 | 0.2082 |

| | | |
|---|---|---|
| Standard Deviation (%) | 0.23% | 0.27% |
| Natural abundance | 0.03809 | 0.2055 |

### Example 2

### Determination of Oxygen and Carbon Isotope Ratios in CO₂ Gas

Oxygen ions in +2 charge state:

| Faraday cup readings | | | Ratio | Ratio |
|---|---|---|---|---|
| ¹⁶O²⁺ (nA) | ¹⁷O²⁺ (nA) | ¹⁸O²⁺ (nA) | ¹⁷O/¹⁶O (%) | ¹⁸O/¹⁶O (%) |
| 4670 | 1.94 | 10.84 | 0.04154 | 0.2321 |
| 4655 | 1.942 | 10.8 | 0.04172 | 0.2320 |
| 4650 | 1.945 | 10.81 | 0.04183 | 0.2325 |
| 4637 | 1.94 | 10.788 | 0.04184 | 0.2327 |
| 4630 | 1.912 | 10.62 | 0.04130 | 0.2294 |
| | | Mean | 0.04164 | 0.2317 |

| | | |
|---|---|---|
| Standard Deviation (%) | 0.55% | 0.58% |
| Natural abundance | 0.03809 | 0.2055 |

Carbon ions in +2 charge state:

| | |
|---|---|
| Faraday cup readings | Ratio |

| ¹²C²⁺ (nA) | ¹³C²⁺ (nA) | ¹³C/¹²C (%) |
|---|---|---|
| 2400 | 26.35 | 1.0979 |
| 2376 | 26.35 | 1.1090 |
| 2370 | 26.15 | 1.1034 |
| 2350 | 25.91 | 1.1026 |
| 2330 | 25.83 | 1.1086 |
| | Mean | 1.1043 |

| | |
|---|---|
| Standard Deviation (%) | 0.42% |
| Natural abundance | 1.1122 |

### Example 3

### Determination of Nitrogen Isotope Ratios in N₂ Gas

| | |
|---|---|
| Faraday cup readings | Ratio |

| ¹⁴N²⁺ (nA) | ¹⁵N²⁺ (nA) | ¹⁵N/¹⁴N (%) |
|---|---|---|
| 10850 | 40.8 | 0.3760 |
| 10740 | 40.7 | 0.3790 |
| 10760 | 40.6 | 0.3773 |
| 10750 | 40.7 | 0.3786 |
| | Mean | 0.3777 |

| | |
|---|---|
| Standard Deviation (%) | 0.35% |
| Natural abundance | 0.3673 |

### Example 4

### Determination of Isotope Ratios in an Organic Compound

The table below lists the ion beam currents measured from the vapour of a sample of nitrobenzene (C₆H₅NO₂), for ions of interest in the +1 charge state (upper half of table) and +2 charge state (lower half of table). In the case of +1 ions, there are significant interferences from hydride ions which make it impossible to measure the isotopic ratios of interest with any accuracy. Using the +2 charge state, the data demonstrates that reasonably accurate isotopic ratios can be determined.

| Measured | | Mass/ | Isotopic | | |
|---|---|---|---|---|---|
| beam current | | charge | ratio of | Measured | Expected |
| (nA) | Ions | ratio | interest | ratio | ratio |
| 1650 | ¹²C⁺ | 12 | — | | |
| 33.6 | ¹³C⁺, CH⁺ | 13 | ¹³C/¹²C | 2.0% | 1.112% |
| 1578 | ¹⁴N⁺ | 14 | — | | |
| 216 | ¹⁵N⁺, NH⁺ | 15 | ¹⁵N/¹⁴N | 13.7% | 0.367% |
| 11420 | ¹⁶O⁺ | 16 | — | | |
| 4570 | ¹⁷O⁺, OH⁺ | 17 | ¹⁷O/¹⁶O | 40.0% | 0.038% |
| 9100 | ¹⁸O⁺, H₂O⁺ | 18 | ¹⁸O/¹⁶O | 79.7% | 0.200% |
| 477 | ¹²C²⁺ | 6 | — | | |
| 5.7 | ¹³C²⁺ | 6.5 | ¹³C/¹²C | 1.195% | 1.112% |
| 480 | ¹⁴N²⁺ | 7 | — | | |
| 1.76 | ¹⁵N²⁺ | 7.5 | ¹⁵N/¹⁴N | 0.367% | 0.367% |
| 3710 | ¹⁶O²⁺ | 8 | — | | |
| 2.74 | ¹⁷O²⁺ | 8.5 | ¹⁷O/¹⁶O | 0.074% | 0.038% |
| 8.3 | ¹⁸O²⁺ | 9 | ¹⁸O/¹⁶O | 0.224% | 0.200% |

1. A method for determining at least one ratio of different isotopes of at least one element in a sample said method comprising:
(i) ionizing the sample to produce ions of the different isotopes of said at least one element, said ions being selected from the group consisting of: multiply charged atomic positive ions, single charged positive ions for hydrogen and single charged positive ions for deuterium;
(ii) separating the charged positive ions of the different isotopes of said at least one element according to their mass-to-charge ratios; and
(iii) determining at least one ratio of the different isotopes of said at least one element separated in step (ii).

2. The method of claim 1, wherein the method comprises determining at least one ratio of different isotopes of a single element in a sample, said method comprising:
(i) ionizing the sample to produce ions of the different isotopes of the element, said ions being selected from the group consisting of: multiply charged atomic positive ions, single charged positive ions for hydrogen and single charged positive ions for deuterium wherein the mass-to-charge ratios of the charged positive ions of the different isotopes are in a mass-to-charge ratio range that is different to the mass-to-charge ratio of other ions produced from said sample;
(ii) separating the charged positive ions of the different isotopes of the element according to their mass-to-charge ratios; and
(iii) determining at least one ratio of the different isotopes of the element separated in step (ii).

3. The method of claim 1, wherein the method comprises determining at least one ratio of different isotopes of at least two different elements in a sample said method comprising:
(i) ionizing the sample to produce ions of the different isotopes of said at least two different elements, said ions being selected from the group consisting of: multiply charged atomic positive ions, single charged positive ions for hydrogen and single charged positive ions for deuterium, wherein the mass-to-charge ratios of the charged positive ions of the different isotopes are in a mass-to-charge ratio range that is different to the mass-to-charge ratio of other ions produced from said sample;
(ii) separating the charged positive ions of the different isotopes of said at least two different elements according to their mass-to-charge ratios;
(iii) determining at least one ratio of the different isotopes of said at least two different elements separated in step (ii).

4. The method of claim 1, wherein the at least one element is selected from the group consisting of: hydrogen, oxygen, sulfur, nitrogen, carbon, silicon, helium, neon, argon, chlorine, uranium and combinations thereof.

5. The method of claim 1, wherein the ions are multiply charged atomic positive ions.

6. The method of claim 5, wherein the multiply charged atomic positive ions have a charge of +2 or +3.

7. The method of claim 6, wherein the at least one element is selected from the group consisting of: oxygen, sulfur, nitrogen, and carbon.

8. The method of claim 7, wherein the sample comprises one or more of the following compounds: water, carbon dioxide, carbon monoxide, methane, dinitrogen oxide, nitrogen monoxide, nitrogen dioxide, ammonia, sulfur dioxide, hydrogen sulphide, sulphur hexafluoride, chloromethane, tetrafluoromethane, tetrafluorosilane, oxygen, ozone and nitrogen.

9. The method of claim 2, wherein the method comprises determining between one and six isotope ratios of a single element.

10. The method of claim 2, wherein the single element is selected from the group consisting of: hydrogen, oxygen, sulfur, nitrogen, carbon, silicon, helium, neon, argon, chlorine, uranium and combinations thereof.

11. The method of claim 2, wherein the ions are multiply charged atomic positive ions.

12. The method of claim 11, wherein the multiply charged atomic positive ions have a charge of +2 or +3.

13. The method of claim 12, wherein the at least one element is selected from the group consisting of: oxygen, sulfur, nitrogen, and carbon.

14. The method of claim 13, wherein the method comprises determining at least one ratio selected from the group consisting of: ¹⁸O/¹⁶O, ¹⁸O/¹⁷O, ¹⁷O/¹⁶O, ¹³C/¹²C, ¹⁵N/¹⁴N, ³³S/³²S, ³⁴S/³²S, ³⁶S/³²S, ³³S/³⁴S, ³³S/³⁶S, and ³⁴S/³⁶S.

15. The method of claim 14, wherein the method comprises determining at least one ratio selected from the group consisting of: ¹⁸O/¹⁶O, ¹⁸O/¹⁷O, ¹⁷O/¹⁶O, ¹³C/¹²C and ¹⁵N/¹⁴N.

16. The method of claim 14, wherein the method comprises determining at least one ratio selected from the group consisting of: ¹⁸O/¹⁶O, ¹⁸O/¹⁷O and ¹⁷O/¹⁶O.

17. The method of claim 14, wherein the sample comprises one or more of the following compounds: water, carbon dioxide, carbon monoxide, methane, dinitrogen oxide, nitrogen monoxide, nitrogen dioxide, ammonia, sulfur dioxide, hydrogen sulphide, sulphur hexafluoride, chloromethane, tetrafluoromethane, tetrafluorosilane, oxygen, ozone and nitrogen.

18. The method of claim 3, wherein the method comprises determining two or three ratios of different isotopes of two, three or four different elements.

19. The method of claim 18, wherein the method comprises determining one ratio of different isotopes of two different elements.

20. The method of claim 3, wherein the at least two different elements are selected from the group consisting of: hydrogen, oxygen, sulfur, nitrogen, carbon, silicon, helium, neon, argon, chlorine, uranium and combinations thereof.

21. The method of claim 3, wherein the ions are multiply charged positive ions.

22. The method of claim 21, wherein the at least two different elements are selected from the group consisting of: oxygen, sulfur, nitrogen, and carbon.

23. An isotope ratio mass spectrometer apparatus comprising:
(i) an ion source capable of producing a beam of multiply charged atomic positive ions and single charged positive ions for hydrogen and single charged positive ions for deuterium;
(ii) a primary analyser adapted to separate said charged positive ions according to their mass-to-charge ratios;
(iii) at least one ion detector to detect said separated charged positive ions.

24. The apparatus of claim 23, wherein the ion source is an electron cyclotron resonance (ECR) source.

25. The apparatus of claim 23, wherein the charged positive ions are multiply charged atomic positive ions.

26. The apparatus of claim 23, wherein the primary analyzer is selected from the group consisting of: a sector field magnet, a Wein filter, a quadrupole mass filter and a time-of-flight measurement system.

27. The apparatus of claim 23, comprising an additional analyzer.

28. The apparatus of claim 23, wherein the at least one detector is a Faraday cup.

29. An isotope ratio mass spectrometer apparatus comprising:
(i) an ion source capable of producing a beam of multiply charged atomic positive ions and single charged positive ions for hydrogen and single charged positive ions for deuterium;
(ii) a primary analyser adapted to separate said charged positive ions according to their mass-to-charge ratios;
(iii) at least two ion detectors to detect said separated charged positive ions.

30. The apparatus of claim 29, wherein the ion source is an electron cyclotron resonance (ECR) source.

31. The apparatus of claim 29, wherein the charged positive ions are multiply charged atomic positive ions.

32. The apparatus of claim 29, wherein the primary analyzer is selected from the group consisting of: a sector field magnet, a Wein filter, a quadrupole mass filter and a time-of-flight measurement system.

33. The apparatus of claim 29, comprising an additional analyzer.

34. The apparatus of claim 29, wherein the at least two detectors are Faraday cups.
